(19) United States
(12) Patent Application Publication
(10) Pub. No.: US 2011/0021100 A1
(43) Pub. Date: Jan. 27, 2011

(54) FABRIC FOR BINDING TAPE, AND BINDING TAPE

(75) Inventors: Masayuki DOI, Mie (JP); Toshitsugu MORII, Mie (JP); Tsutomu TANASE, Gifu (JP)

Correspondence Address: GREENBLUM & BERNSTEIN, P.L.C., 1950 ROLAND CLARKE PLACE, RESTON, VA, 20191, US

(73) Assignees: SUMITOMO WIRING SYSTEMS, LTD., Mie (JP); TOHKAI THERMO CO., LTD., Gifu (JP)

(21) Appl. No.: 12/820,473

(22) Filed: Jun. 22, 2010

(30) Foreign Application Priority Data
Jul. 22, 2009 (JP) P2009-171078

(51) Int. Cl. C09J 7/04; D04B 1/14

(52) U.S. Cl. 442/149; 442/309

(57) ABSTRACT

A binding tape 10 includes a base material 11 and an adhesive layer 12 that is made on a back side of the base material 11 which contacts an outer peripheral surface of the wire bundle W. The base material 11 is made up of a single sheet of fabric 20. The fabric 20 is made of knitted fabric that is knitted by use of warp yarn 21 and weft yarn 22, both of which are made from polyester fibers, by means of a warp-knitting weft insertion method. A thickness of the warp yarn 21 is 22 to 56 decitexes; a thickness of the weft yarn 22 is 440 decitexes or more; and a density of the warp yarn 21 is 10 to 30 wales/inch.

### CROSS-REFERENCE TO RELATED APPLICATION

This application is based on and claims priority under 35U.S.C. §119 from Japanese Patent Application No. 2009-171078 filed on Jul. 22, 2009.

### BACKGROUND

1. Technical Field

The present invention relates to fabric for a binding tape used in binding a wire harness, or the like, as well as to a binding tape.

2. Description of the Related Art

Hitherto known countermeasures to protect a wire bundle making up a wire harness laid in an automobile, or the like, employ a corrugated tube (see JP-A-2000-353432). The product has a structure including winding an adhesive tape (a lower winding) including PVC (polyvinyl chloride), an unwoven fabric, and the like, as a base material around a wire bundle (a binding function), to thus tie the bundle together; housing the wire bundle in a corrugated tube while a slit cut in the tape in its axial direction is being opened (a protective function), and winding the adhesive tape (an upper winding) around an outer radius of the corrugated tube in order to prevent further opening of the slit. However, the structures involve a large number of operation processes and a large number of components, as well, and hence raise a problem of a cost increase.

Therefore, various binding tapes having both the binding function and the protective function have recently been proposed. In any of the tapes, a tape base material exhibits high strength, cannot be cut by hand, and involves a need for use of a tool, like scissors. In the end, the tapes still face a problem of work involving consumption of efforts. A further improvement in the binding tapes has been desired.

### SUMMARY

The present invention has been completed in view of the circumstances and aims at providing fabric for a binding tape that has both a tying function and a protective function and that enables manual cutting of the tape; namely, exhibits superiorly ease of cut, as well as providing a binding tape.

According to a first aspect of the invention, there is provided a fabric for a binding tape including:

warp yarn including polyester fibers having a thickness of 22 to 56 decitexes, and

weft yarn including polyester fibers having a thickness of 440 decitexes or more,

wherein the warp yarn and the weft yarn are knitted by means of a warp-knitting weft insertion method, and

wherein a density of the warp yarn is 10 to 30 wales/inch.

The fabric having the structure exhibits appropriate rigidity, such as flexural rigidity; can be held in a tied state without involvement of a break even when the fabric is wound into a wire bundle; namely, a tying function is ensured. The fabric also exhibits appropriate abrasion resistance; namely, a protective function is also ensured. In the meantime, when the fabric is cut by hand, the fabric is torn while pieces of the warp yarn located between pieces of adjacent weft yarn at a predetermined location are being broken. Since the warp yarn whose thickness (22 to 56 decitexes) conforms to limited shear strength is laid at a comparatively coarse density (10 to 30 wales/inch). Therefore, the fabric can be torn by hand while a small number of pieces of warp yarn are respectively, sequentially being cut. In short, superior ease of manual cutting is achieved.

The fabric for a binding tape can also be configured as follows:

(1) According to a second aspect of the invention, there is provided the fabric as set forth in the first aspect,

wherein at least either the warp yarn or the weft yarn exhibit thermal adhesiveness to adhere the warp yarn and the weft yarn thermally with each other.

Hence, since the warp yarn and the weft yarn are in a thermally adhered state, when the fabric is cut by hand, fraying of an extremity of the warp yarn, or the like, which would otherwise arise at a torn portion, is prevented.

(2) According to a third aspect of the invention, there is provided a fabric including:

a plurality of the fabrics as set forth in the first or second aspect which are stacked, and

an adhesive sandwiched between the fabrics.

The tying function and the protective function of the fabric can be improved while superior ease of manual cutting is assured.

(3) According to a fourth aspect of the invention, there is provided the fabric as set forth in any one of the first to third aspects,

wherein the polyester fibers of the weft yarn are made from yarn including a plurality of polyester filaments which are twisted.

Therefore, generation of fluff, which would otherwise be caused by dispersion of fibers, is inhibited.

(4) According to a fifth aspect of the invention, there is provided the fabric as set forth in the fourth aspect,

wherein some of the plurality of polyester filaments exhibit thermal adhesiveness.

It is possible to inexpensively address a case where weft yarn exhibiting thermal adhesiveness is obtained.

According to a sixth aspect of the invention, there is provided a binding tape including:

the fabric as set forth in any one of the first to fifth aspects, and

an adhesive layer formed on one side of the fabric.

Advantages corresponding to the respective advantages of the fabric can be yielded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an exemplary cross-sectional view of a binding tape of a first embodiment of the present invention;

FIG. 2 is an exemplary diagrammatic view of a knitted fabric making up fabric;

FIG. 3 is an exemplary oblique perspective view of a roll of the binding tape;

FIG. 4 is an exemplary side view showing a mode in which the binding tape is wound around a wire bundle; and

FIG. 5 is an exemplary cross-sectional view of a binding tape of a second embodiment of the present invention.

### DETAILED DESCRIPTION

Various embodiments according to the invention will be described hereinafter with reference to the accompanying drawings.

### First Embodiment

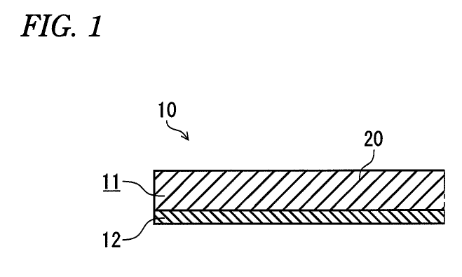

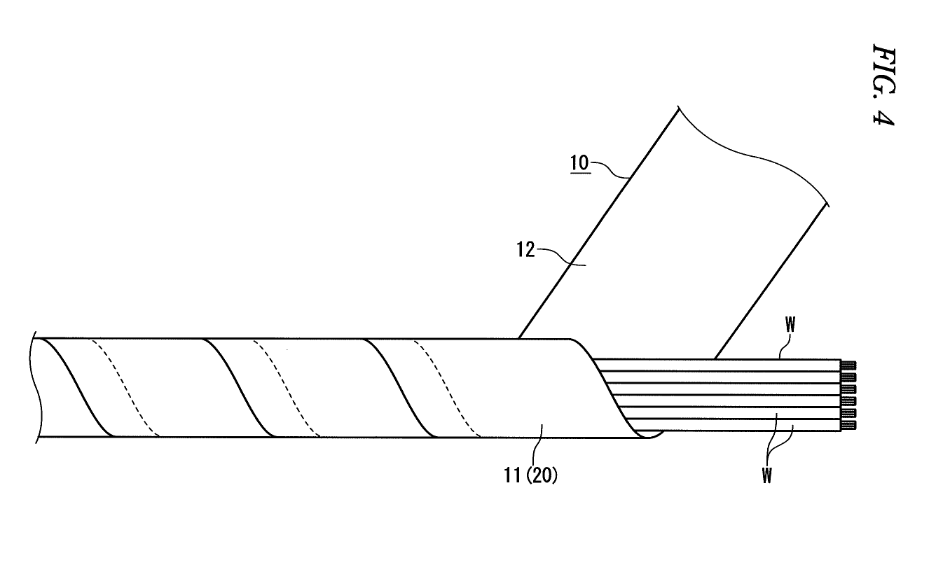

A first embodiment of the present invention is hereunder described by reference to FIGS. 1 through 4. The present embodiment exemplifies a binding tape 10 used for binding a wire bundle W making up a wire harness laid in an automobile. As shown in FIG. 4, the wire bundle W is a bundle of a plurality of covered electric cables “w” or shielded electric wires.

The binding tape 10 includes a base material 11 and an adhesive layer 12 that is made on a back side of the base material 11 which contacts an outer peripheral surface of the wire bundle W.

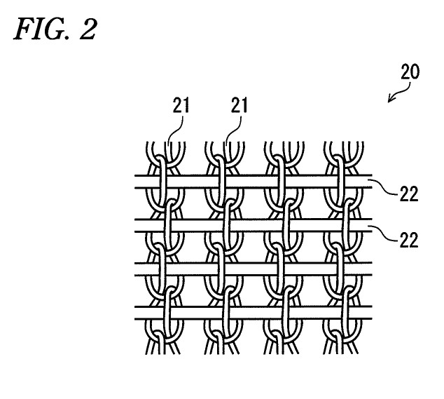

The base material 11 is made up of a single sheet of fabric 20. The fabric 20 is made of knitted fabric that is knitted by use of warp yarn 21 and weft yarn 22, both of which are made from polyester fibers, by means of a warp-knitting weft insertion method. The fabric knitted by the warp-knitting weft insertion method is fabric that assumes a configuration in which the warp yarn 21 is knitted in the form of continual loops, as diagrammatically shown in FIG. 2, and that is made by inserting the weft yarn 22 into the loops.

More specifically, the warp yarn 21 is made of yarn that is a combination of a plurality of untwisted polyester fibers (single yarn) exhibiting thermal adhesiveness, and a preferred thickness of the warp yarn 21 is 22 to 56 decitexes (dtex). When the thickness of the warp yarn is less than 22 decitexes, shear strength is too small. On the contrary, when the thickness of the warp yarn is in excess of 56 decitexes, shear strength becomes too large.

The weft yarn 22 is made from falsely-twisted polyester yarn made by falsely twisting a plurality of polyester fibers (pieces of single yarn). A preferred thickness of the weft yarn 22 is 440 decitexes or more. When the thickness of the weft yarn is less than 440 decitexes, rigidity, such as flexural rigidity, acquired when knitted fabric is produced becomes deficient.

Knitted fabric is produced by knitting the warp yarn 21 and the weft yarn 22 having the respective thicknesses by means of the warp-knitting weft insertion method. However, a preferred density of the warp yarn 21 is 10 to 30 wales (wale per piece of yarn)/inch, and a preferred density of the weft yarn 22 is 40 to 60 coarses (coarse per piece of yarn)/inch.

Further, the fabric knitted as mentioned above undergoes heat treatment, whereby the warp yarn 21 and the weft yarn 22 are thermally welded, whereupon the final fabric 20 is completed.

The weft yarn 22 having the thickness (440 decitexes or more), such as that mentioned above, is primarily knitted into the thus-produced fabric 20 at a density of 40 to 60 coarses/inch. Consequently, the fabric 20 exhibits appropriate rigidity, such as flexural rigidity; can be held in a tied state without involvement of a break even when the fabric is wound into a wire bundle W; namely, a tying function is ensured.

In the meantime, the protective function is evaluated by means of abrasion resistance. In relation to “abrasion,” it is assumed that, when the fabric 20 undergoes external load while wound around the wire bundle W, a hole will be formed to such an extent that the internal wire bundle W is exposed outside, the fabric 20 of the present embodiment is said to exhibit required abrasion resistance by possessing appropriate rigidity, such as that mentioned above. The abrasion resistance is also verified by an abrasion resistance tester defined by the JIS (Japanese Industrial Standards); namely, the protective function is also assured.

When the fabric 20 is cut by hand, the fabric is torn while pieces of the warp yarn 21 located between pieces of adjacent weft yarn 22 at a predetermined location are being broken. The warp yarn 21 whose thickness (22 to 56 decitexes) conforms to limited shear strength is laid at a comparatively coarse density (10 to 30 wales/inch). Therefore, the fabric 20 can be torn by hand while a small number of pieces of warp yarn 21 are respectively, sequentially being cut. In short, superior ease of manual cutting is achieved.

When the density of the warp yarn 21 becomes highly density in excess of 30 wales/inch, it is necessary to cut a plurality of pieces of warp yarn 21 by one operation, so that the fabric cannot be readily cut by hand. On the contrary, when the warp yarn 21 comes to a low density of less than 10 wales/inch, the fabric may be inadvertently torn.

A more appropriate density of the warp yarn 21 is 18 to 22 wales/inch.

Moreover, fibers exhibiting thermal adhesiveness are used for the warp yarn 21, and the warp yarn 21 and the weft yarn 22 thermally adhere to each other. Hence, when the fabric 20 is cut by hand as mentioned above, fraying of an extremity of the warp yarn 21, or the like, which would otherwise arise at a torn portion, is prevented.

Further, the fabric 20 of the present embodiment is basically knitted fabric and has an appropriate thickness and elasticity. Therefore, the fabric is superior in prevention of hammering sound, which would otherwise arise when another member hits the fabric 20, and a rasp, which would otherwise arise when another member rubs against the fabric 20. Namely, the fabric exhibits a superior sound deadening characteristic, as well.

Since the weft yarn 22 is made from yarn including a plurality of twisted polyester fibers. Therefore, generation of fluff, which would otherwise be caused by dispersion of fibers, is inhibited.

The binding tape 10 is manufactured as follows. As shown in FIG. 1, the adhesive layer 12 is formed on the back of one sheet of fabric 20 corresponding to the above-produced base material 11. Acrylic adhesives and rubber-based adhesives are mentioned as an adhesive forming the adhesive layer 12.

The fabric 20 (the base material 11) on the back of which there is formed such an adhesive layer 12 is cut along a direction of the warp yarn 21 at predetermined intervals in a direction of the weft yarn 22, whereupon the binding tape 10 having a predetermined width and the warp yarn 21 laid in its lengthwise direction is thus made.

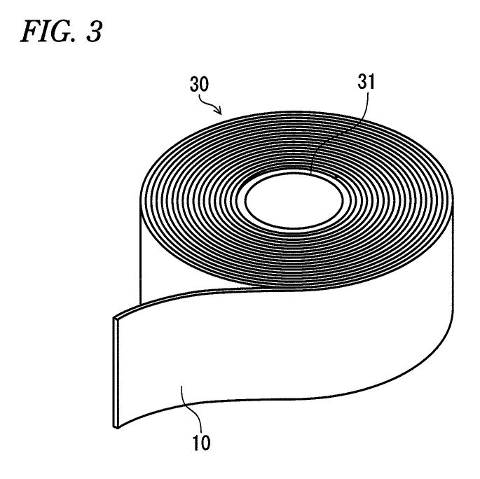

The width of the binding tape 10 is set to; for instance, a value of less than 100 mm. As shown in FIG. 3, the binding tape 10 is prepared as a so-called roll 30 in which the binding tape is wound around a paper core tube 31.

On occasion of the wire bundle W making a portion of a wire harness being protected, the binding tape 10 is wound around the wire bundle W by manual operation. As shown in FIG. 4, in the present embodiment, the binding tape 10 is helically coiled around an outer periphery of the wire bundle W while being fed from the roll 30 such that a lap exists between side edges of the tape, whereby the adhesive layer 12 on the back of the binding tape 10 is bonded to the outer peripheral surface of the wire bundle W. A lapping form includes a lap existing over one-fourth of a total width (a quarter lap), a lap existing over a one-half of a total width (a half lap), and the like.

When the binding tape 10 is wound over a predetermined length of the wire bundle W, the binding tape 10 must be cut. The binding tape 10 is cut along its widthwise direction; namely, the tape is torn while pieces of the warp yarn 21 located between adjacent pieces of weft yarn 22 are being broken. However, the tape exhibits a superior manual cut characteristics in that direction as mentioned above, and hence the tape can be readily cut by hand. Since the warp yarn 21 and the weft yarn 22 thermally adhere to each other, fraying of an extremity of the warp yarn 21, or the like, which would otherwise arise after the tape has been cut, is avoided.

When the binding tape 10 of the embodiment is wound around the wire bundle W, the following advantage can be yielded.

Since the base material 11 (the fabric 20) of the binding tape 10 has both a predetermined tying function and a predetermined protective function, the binding tape can reliably tie and protect the wire bundle W.

In addition, attachment of the binding tape 10 requires mere helical winding of the binding tape 10 around the outer periphery of the wire bundle W while being fed from the roll 30 such that a lap exists between side edges of the binding tape. In particular, since the binding tape 10 exhibits superior ease of manual cutting, the tape can be readily cut by hand even when the tape is to be cut after having finished undergoing predetermined winding. Therefore, operation for attaching the binding tape 10 serving as a protective material can be efficiently performed.

Since the binding tape 10 exhibits a superior sound deadening characteristic, it becomes possible to effectively prevent generation of noise, which would otherwise arise when a wire harness collides against a peripheral material, or the like, or when the wire harness rubs against the material, for reasons of vibrations.

### Second Embodiment

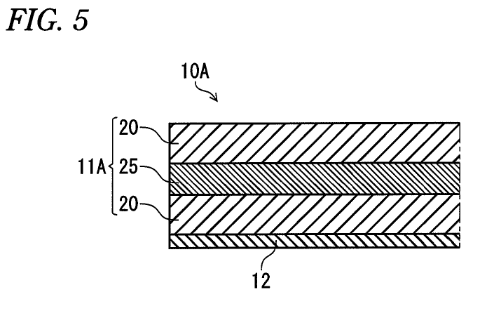

FIG. 5 shows a second embodiment of the present invention. In the embodiment, a base material 11A of a binding tape 10A assumes a three-layer structure in which two sheets of fabric 20 (knitted fabric) illustrated in connection with the first embodiment are laminated together with an adhesive 25. Polyamide-based adhesives are exemplified as the adhesive 25. Further, the adhesive layer 12 corresponding to a coating of acrylic adhesives, rubber-based adhesive, and the like, is formed on the back side of the base material 11A.

Since the base material 11A illustrated in connection with the second embodiment assumes the three-layer structure, the rigidity of the base material is enhanced, and a tying function is improved. Further, in relation to the protective function, when the base material undergoes an external load, the load is dispersed primarily over the two sheets of fabric 20; namely, stress is eased, so that the base material is considered to be less subject to abrasion. As a consequence, the protective function is enhanced.

Meanwhile, the ease of manual cutting is principally based on the thickness and density of the warp yarn 21 making up the fabric 20 (knitted fabric). Therefore, even in the case of a three-layer structure including two sheets of fabric 20, superior ease of manual cutting can be accomplished by use of the fabric 20 (knitted fabric) whose thickness and density are set to smaller values within their respective allowable ranges.

The binding tape 10A of the second embodiment exhibits an improved tying function and an improved protective function and can also provide superior ease of manual cutting. The binding tape 10A can be further improved even in connection with a sound deadening characteristic.

### Another Embodiment

The present invention is not limited to the descriptions and the embodiments described by reference to the drawings. For instance, embodiments, such as those provided below, also fall within a technical scope of the present invention.

(1) The embodiments exemplify a case where the warp yarn exhibits thermal adhesiveness. However, there may also be adopted warp yarn not exhibiting thermal adhesiveness, including weft yarn that does not exhibit thermal adhesiveness, and fabric including both the warp yarn and the weft yarn also falls within a technical scope of the present invention.
(2) Conversely, thermal adhesiveness is not limited to the warp yarn. The weft yarn may also exhibit thermal adhesiveness, or both the warp yarn and the weft yarn may exhibit thermal adhesiveness. In the case of weft yarn, weft yarn in which only some of a plurality of polyester filaments making up the weft yarn may be used.
(3) The multilayer structure of the fabric may be a laminated structure using three sheets or more of fabric.
(4) The embodiments exemplify the case where polyester fibers making up the weft yarn are twist yarn. However, the polyester fibers may also be untwist yarn.
(5) A way to wind the binding tape is not limited to a helical roll exemplified in the embodiments. There may also be adopted another winding method, such as a so-called sushi roll in which the tape is cylindrically rolled with its both side edges lapped, a cylindrical roll with its both side edges butt-seamed, and the like.

According to the exemplary embodiments of the present invention, there can be provided a fabric for a binding tape that has both a tying function and a protective function and that exhibits superior ease of manual cutting and a binging tape.

What is claimed is:

1. A fabric for a binding tape comprising:
warp yarn including polyester fibers having a thickness of 22 to 56 decitexes, and
weft yarn including polyester fibers having a thickness of 440 decitexes or more,
wherein the warp yarn and the weft yarn are knitted by means of a warp-knitting weft insertion method, and
wherein a density of the warp yarn is 10 to 30 wales/inch.

2. The fabric as set forth in claim 1,
wherein at least either the warp yarn or the weft yarn exhibit thermal adhesiveness to adhere the warp yarn and the weft yarn thermally with each other.

3. A fabric comprising:
a plurality of the fabrics as set forth in claim 1 which are stacked, and
an adhesive sandwiched between the fabrics.

4. The fabric as set forth in claim 1,
wherein the polyester fibers of the weft yarn are made from yarn including a plurality of polyester filaments which are twisted.

5. The fabric as set forth in claim 4,
wherein some of the plurality of polyester filaments exhibit thermal adhesiveness.

6. A binding tape comprising:
the fabric as set forth in claim 1, and
an adhesive layer formed on one side of the fabric.
